(19) United States
(12) Patent Application Publication
(10) Pub. No.: US 2022/0281632 A1
(43) Pub. Date: Sep. 8, 2022

(54) A CONTAINER FOR FOODSTUFFS AND A METHOD FOR MANUFACTURING SAID CONTAINER

(71) Applicant: MUSTANGPACK S.R.L., Piazzola Sul Brenta (Padova) (IT)

(72) Inventors: Tobia ZORZETTO, Piazzola Sul Brenta (Padova) (IT); Claudio Ernestino ZANARELLA, Piazzola Sul Brenta (Padova) (IT)

(21) Appl. No.: 17/632,345

(22) PCT Filed: Jul. 28, 2020
(86) PCT No.: PCT/IB2020/057095

§ 371 Date: Feb. 2, 2022

(30) Foreign Application Priority Data
Aug. 9, 2019 (IT) 102019000014529
Aug. 9, 2019 (IT) 102019000014538
Aug. 9, 2019 (IT) 102019000014544

(51) Int. Cl. B65D 5/24; B65D 5/20; B65D 5/56; B65D 65/46; B65D 65/40; B65D 5/42; B65D 5/489; B65D 85/76; B31B 50/26; B31B 50/74; B31B 50/62; B31B 50/82

(52) U.S. Cl. CPC B65D 5/246; B65D 5/2033; B65D 5/563; B65D 65/466; B65D 65/40; B65D 5/4287; B65D 5/4802; B65D 85/76; B31B 50/26; B31B 50/741; B31B 50/626; B31B 50/82; B31B 2105/0024

(57) ABSTRACT

A container for foodstuffs includes a containment body having a polygonal bottom wall and perimeter side walls connected to each other and to the polygonal bottom wall so as to define a food containment volume open at the top at an upper opening. At least two side flaps and one upper flap extend from each perimeter side wall. Each side flap is connected to the respective side wall through a respective side folding line and abuts against and is bonded to a respective adjacent side flap, defining a supporting element outside the containment volume. Each upper flap is connected to the respective side wall through a respective first upper folding line along which it is folded away from the containment volume so as to define an edge portion of the container suitable to receive a closure element.

### FIELD OF THE INVENTION

The present invention relates to a container for foodstuffs. The present invention also relates to a method for manufacturing said container for foodstuffs.

### DISCUSSION OF THE PRIOR ART

Containers for foodstuffs in different shapes and sizes, and suitable for containing different kinds of foodstuffs are known in the prior art. Such containers may have a compact shape, suitable for containing nuts or similar foodstuffs, or may be wider (like a tray) suitable for containing foodstuffs of other sorts such as fruit, vegetables, meat, cheese, fish and so on.

Depending on the type of storage required, such containers may be made of biodegradable materials or plastic materials such as polyester or polyethylene.

In particular, in the case of biodegradable materials, the containers are usually made of cardboard/card using conventional paper and cardboard processing methods in which the containers can be shaped by means of folding and forming after applying the necessary dots of glue so that they maintain their shape when the manufacturing process has been completed.

Such containers, which have no upper edge and necessarily have a quadrangular shape, must be wrapped in plastic by means of flow pack wrappers or similar machines, and thus involve the production and use of considerable amounts of plastic material which, though recyclable, is no longer desirable on the market for reasons of environmental sustainability.

This problem is even greater in the field of distribution and storage of fresh foods, in which at present almost all containers are made of polyethylene/polythene, a so-called gas-tight material (i.e., the material acts as a barrier to the diffusion of gas such as oxygen, etc.), but which, due to its structure, necessarily involves the use of large amounts of plastic material.

The base material is, in fact, heated, stretched and folded during its formation, significantly reducing its thickness which must therefore initially be high (greater than 500 μm).

Moreover, with reference to the containers described above, transportation-related problems should not be overlooked, in that the pre-shaped plastic trays, though stackable, take up a large volume of space and this reduces the margins arising from the relatively economical production process.

### Purpose of the Invention

The technical purpose of the present invention is to provide a container for foodstuffs and a method for manufacturing said container for foodstuffs able to overcome the inconveniences found in the prior art solutions.

In particular, the purpose of the present invention is to provide a container for foodstuffs and a method for manufacturing said container for foodstuffs that are ecologically very sound and, at the same time of high quality.

More specifically, the purpose of the present invention is to provide a container that is environmentally friendly and at the same time suitable for use with conventional film heat-sealing machines.

A further purpose of the present invention is to provide a container for foodstuffs that is completely recyclable and, at the same time, can act as a gas barrier.

Yet another purpose of the present invention is to provide a container for foodstuffs and a method of manufacturing said container that are suitable to permit the use of the container to store cold cuts and the like.

Said purposes are achieved with a container for foodstuffs having the characteristics of one or more of claims 1 to 7, and a method for manufacturing said container for foodstuffs having the characteristics of one or more of claims 8 to 10.

In particular, the container comprises a box-like body made of a material that is at least partially recyclable and/or biocompostable, having a bottom wall (polygonal) and perimeter side walls connected to each other along respective connection lines and to said bottom wall.

The bottom wall and the side walls thus define a food containment volume facing an inner layer of the box-like body and open at the top at an upper opening.

Preferably, at least two side flaps and one upper flap extend from each perimeter side wall.

Note that the terms “side” and “upper” are used here to refer to the side wall of the container in a condition of use, that is, with the bottom wall of the box-like body resting on a horizontal plane.

Preferably, each side flap is connected to the respective side wall through a respective side folding line, defining a connection edge of the respective perimeter side wall.

Preferably, furthermore, each side flap abuts against and is bonded to a respective adjacent side flap, defining a supporting element outside said containment volume.

Advantageously, in this way, the two abutting flaps double the thickness of the material of which the box-like body is made, providing a strong structural support (for application) to the side walls even in the presence of a material of limited thickness.

Moreover, in some preferred embodiments, this is further emphasised by the fact that the supporting element abuts against and is bonded (externally) to one of the adjacent side walls.

According to one aspect of the invention, each upper flap is connected to the respective side wall through a respective first upper folding line, along which it is folded away from the containment volume.

In this way, the upper flap defines an edge portion of the container suitable to receive a closure element of the container, preferably a sheet of laminated heat-sealable plastic material.

Advantageously, the edge of the container thus folded facilitates the application of closure elements of the type typically used in the food packaging industry, using conventional heat-sealing machines.

In that respect, each upper flap preferably at least partially overlaps and is bonded to at least one adjacent upper flap, so that said upper flaps define a continuous edge of the container.

Note that the term “continuous edge” refers here to the fact that there are no structural breaks in the edge between one edge portion and the adjacent edge portion, as there is always at least one bonded or overlapping portion between the two.

Advantageously, in this way the continuous edge of the container facilitates the application of the closure element and at the same time defines a reinforcing perimeter belt, which stiffens the structure of the container.

Preferably, each pair of adjacent side flaps and/or of adjacent upper flaps comprises a layer of heat-sealed lacquer interposed between the flaps and suitable to bond them to one another. This advantageously eliminates the need for an adhesive to be applied locally, since there is already a layer of heat-sealable lacquer applied previously (to the blank) in the area of the overlap points.

Preferably, each upper flap comprises a folded portion which is folded in relation to said edge portion along a second upper folding line.

Advantageously, the presence of a folded portion in the area of the continuous edge of the container defines a very strong structural stiffening element that, especially at the corners of the structure, is a decisive factor in making the container manufactured in this way comparable to the plastic containers currently available.

According to a further aspect of the invention, additional or alternative to those described above, the box-like body is made of a multi-layer material having an outer layer made of recyclable and/or biocompostable material and an inner heat-sealable layer made of gas-tight material suitable to come into contact with foodstuffs.

Preferably, said container further comprises a plurality of overlapping sealing elements bonded to said inner layer in the area of said connection lines and arranged at least partially over the respective edge portion of the container.

Advantageously, in this way the only possible “leakage” points inside the box-like body, along the connection lines close to the edge of the container, are occluded by the presence of the sealing elements, thus ensuring the gas-tightness of the container.

In that context, note that the sealing elements are bodies/layers that are separate from the inner layer of the box-like body, applied locally and/or during or after a container forming step (as will be described in more detail later on).

According to a further aspect of the invention, additional or alternative to those described above, each pair of upper flaps bonded to one another comprises a first and a second upper flap.

The first upper flap comprises a folded portion which is folded in relation to the edge portion along the second upper folding line described previously and is provided with at least one lower extension fin which is adjacent to and coplanar with said folded portion.

The second upper flap instead comprises at least one upper extension fin which is adjacent to and coplanar with the respective edge portion.

Preferably, the outer layer of the lower extension fin abuts against and is bonded to the outer layer of the upper extension fin.

Furthermore, the upper extension fin is coplanar with the edge portion of the first upper flap so as to define a continuous edge of said container.

Thus, advantageously, the configuration of the upper flaps described above gives the container a flat edge on which there are no “steps” or dips that would undermine the gas-tightness and the connection with the closure element.

Preferably, to strengthen the edge structure, the second upper flap also comprises a folded portion which is folded in relation to said edge portion along a second upper folding line, adjacent to and coplanar with the lower extension fin of the first upper flap.

Note that, preferably, each upper extension fin is bonded to the respective lower extension fin by a layer of heat-sealable lacquer.

Advantageously, in this way the layer of heat-sealable lacquer can be applied to the outer layer (made of paper/cardboard) of the two extension fins at the time of creating the blank, and then only activated in the step of forming the container, in order to guarantee a much better mechanical seal than would be obtained by joining two fins made of heat-sealable plastic.

According to a further aspect of the invention, additional or alternative to those described above, the bottom wall of the box-like body has at least one window bounded by at least two side edges at least partially facing one another.

The bottom wall further comprises at least one partition wall rising transversely from at least one of said side edges of the window and towards the inside of the containment volume up to a free end thereof.

Preferably, the container comprises a cover element heat-sealed to the inner layer of the bottom wall and arranged astride said at least two edges so as to occlude the window.

The cover element is arranged over said free end of the partition wall and defines a bulge in the bottom wall.

Advantageously, a container thus made of biodegradable and/or compostable material (e.g., paper/cardboard) is provided with the bulges typical of plastic containers and useful for facilitating the positioning and aeration of fresh products such as cold cuts or cheese.

As discussed above, the present invention also relates to a method for manufacturing a container for foodstuffs, preferably but not necessarily the container described above.

Preferably, the method consists in preparing a flat blank having a first face and a second face opposite to one another, corresponding, respectively, to the inner layer and to the outer layer of the box-like body.

The flat blank comprises a polygonal base panel perimetrically bounded by a plurality of internal folding lines, and a plurality of side panels, equal in number to said plurality of internal folding lines.

The side panels are connected to the base panel by said internal folding lines.

Preferably, each side panel is provided with:
a central portion connected to said base panel,
a pair of side tabs arranged on opposite sides of said central portion and connected to said central portion by side folding lines,
an external tab arranged outside said central portion and connected thereto by a first external folding line.

According to the method, the blank is preformed by at least partially folding, in the area of said first face, said side panels, with respect to said base panel along said internal folding lines.

The blank is then formed so as to obtain the container for foodstuffs described above, in which:
the polygonal bottom wall corresponds to the base panel of the blank;
the perimeter side walls correspond to the central portions of the side panels of the blank.

According to one aspect of the invention, the step of forming the blank consists in folding said side tabs along said side folding lines towards the outside of the containment volume, that is to say, by turning the tabs to bring the second face of the side tab angularly close to the first face of the corresponding central portion.

The folding step continues until, in the area of said first face, each side tab of a side panel abuts against a corresponding side tab of an adjacent side panel.

The two side tabs, abutting against each other, are then bonded to one another to define supporting elements (substantially vertical) of the box-like body. Said supporting elements are on the outside of the containment volume.

Preferably, moreover, each external tab is folded along the respective first external folding line so as to define an edge portion of the container suitable to receive a closure element. Thus, after the folding step, the external tab is arranged as a shelf in relation to the central portion of the respective side panel.

According to the preferred embodiment, each external tab partially overlaps and is bonded to at least one adjacent external tab, so as to define the continuous edge of the container described above.

According to a further aspect of the invention, each external tab is also folded along a respective second external folding line (further out than the first) so as to define a folded portion of the edge.

According to a further inventive aspect of the method, alternative or additional to those described above, the forming step comprises the application of a plurality of sealing elements to the first layer of the blank, overlapping them in the area of said connection lines between the side walls and arranging them at least partially over the respective edge portions of the container (i.e., the corresponding portions of the external tabs).

Preferably, the sealing elements are bonded to the box-like body in the area of application, during or after the forming step and, more preferably, by applying heat.

According to another aspect of the invention, alternative or additional to those described above, each pair of adjacent side panels of the blank is provided with a corresponding pair of adjacent external tabs, in particular a first and a second external tab.

The first external tab comprises a first portion, bounded by the external folding lines, and a second portion, which extends starting from the second external folding line away from the first external folding line.

This second portion is provided with at least one extension fin projecting laterally with respect to the first portion.

The second external tab comprises, in turn, at least a first portion adjacent to the first external folding line and is provided with at least one extension fin projecting laterally with respect to the respective central portion.

With the blank having this shape, the forming step consists in folding the second portion of the first tab and bringing it to abut beneath the first portion, so that the extension fin projects laterally and from the bottom of said portion with its second face facing upwards.

At this point, the second face of said extension fin of the first external tab is brought to abut against the second face of said extension fin of the second external tab, so that said extension fin is coplanar with the first portion of the first external tab to define a continuous edge of said container.

The extension fins are then bonded to one another, preferably by heat sealing and, more preferably, by applying a heat-sealable lacquer (before the forming step).

According to another aspect of the invention, the base panel has a window bounded by a closed perimeter line having at least a first and a second edge which at least partially face one another.

The window is at least partially occluded by a partition wall pivotally attached to the panel at the first edge. Thus, preferably, the first edge and the partition wall define, at the level of the blank, the edge and the partition wall described above at the level of the container.

A sheet of heat-sealable plastic material is placed over the window in the area of said first face, so that said sheet of plastic material is arranged over the closed line and the window is completely covered by the sheet.

Preferably, the sheet of heat-sealable plastic material is bonded to the first face of the base panel along a closed sealing line; the sealing line is outside the closed perimeter line that delimits the window.

Preferably, at this point, the partition wall is pushed (in the area of the second face) against the sheet of heat-sealable plastic material and folded along the first edge of the window, until it is arranged transversely to the first face (or inner face).

The sheet of heat-sealable plastic material is configured to deform following the movement of the partition wall, rising over it and keeping said window covered and so as to define a bulge in a bottom wall of said container.

Preferably, in that respect, the sheet of heat-sealable plastic material undergoes a heating step which is performed before or during the step of pushing the partition wall, to make it soft and facilitate its deformation.

Advantageously, thanks to this method, bulges, bumps and ridges can be formed on the bottom wall of a container made of biodegradable or compostable material, preferably paper/cardboard or similar material, that is, of a mainly non-deformable material.

This characteristic also makes the product particularly suitable for the storage and sale of fresh foodstuffs such as cold cuts, thanks to the presence of the bumps and to the gas-tight nature of the base material and of the sheet of plastic material.

### BRIEF DESCRIPTION OF THE DRAWINGS

These and further characteristics, and the respective technical advantages of a container for foodstuffs and a method for manufacturing said container for foodstuffs will be more apparent from the description that follows of a preferred and non-exclusive embodiment represented solely by way of non-limiting example in the accompanying drawings, in which:

FIGS. 1 and 2 are perspective views, from above and from below, of a container for foodstuffs according to the present invention, in a first embodiment;

FIG. 3 shows a first detail of a container for foodstuffs according to one aspect of the present invention;

FIG. 3a shows a sequence of steps for manufacturing the detail illustrated in FIG. 3;

FIG. 4 shows a sequence of steps for manufacturing a second detail of a container for foodstuffs according to one aspect of the present invention;

FIG. 5 shows the detail illustrated in FIG. 4 in an alternative embodiment;

FIG. 6 shows a sequence of steps for manufacturing a third detail of a container for foodstuffs according to one aspect of the present invention;

FIG. 7 shows a flat blank for manufacturing a container for foodstuffs having the detail illustrated in FIG. 6;

FIG. 8 shows a sequence of steps for manufacturing a fourth detail of a container for foodstuffs according to one aspect of the present invention;

FIG. 9 shows a perspective view from above of a container for foodstuffs according to the present invention, according to the embodiment of the detail illustrated in FIG. 8;

FIG. 10 shows a flat blank for manufacturing a container for foodstuffs having the detail illustrated in FIG. 8.

### DETAILED DESCRIPTION OF PREFERRED EMBODIMENTS OF THE INVENTION

With reference to the accompanying Figures, reference numeral 1 denotes a container for foodstuffs that, for the sake of simplicity, will be referred to hereinafter as container 1.

The term foodstuffs is used to mean any kind of fresh or non-fresh food including, for example, nuts, dried fruit, vegetables, meat, dairy products and so on.

The container 1 comprises a box-like body 2 made of a material that is at least partially recyclable and/or biocompostable starting from a substantially flat blank 100.

Preferably, said at least partially recyclable and/or biocompostable material is a cellulosic material, more preferably made of paper, cardboard or card.

More preferably, the box-like body 2 is mainly made of virgin long-fibre paper or kraft paper or wood fibre.

According to the preferred embodiment, the box-like body 2 is made of a multilayer material having an outer layer 2a made of said recyclable and/or biocompostable material and a heat-sealable inner layer 2b, which is gas-tight and made of a material suitable to come into contact with food.

Preferably, the inner layer 2b is made of polyester or polypropylene or polythene or other suitable plastic materials.

Preferably, the inner layer 2b has a thickness and basis weight such as to constitute less than 10% of the weight of the box-like body 2.

In other words, the inner layer 2a preferably makes up at least 90% and more preferably 95% of the weight of the box-like body 2.

Advantageously, in this way the box-like body is completely recyclable within the paper supply chain, even though it comprises a layer of gas-tight material.

Preferably, the box-like body comprises a bottom wall 3 and a plurality of perimeter side walls 4 connected to each other along respective connection lines 4a and to the bottom wall 3 so as to define a food containment volume “V”.

The containment volume “V” preferably faces the inner layer 2b and is open at the top at an upper opening which, in use, is preferably closed by a closure element.

In the preferred embodiment, the bottom wall 3 is substantially polygonal, that is to say, bounded by a perimeter edge 3a defined by a closed, not interwoven broken line.

The perimeter edge 3a thus has a plurality of sides that are adjacent to each other and, preferably, equal in number to the number of side walls 4.

Each perimeter wall 4 is connected (pivotally attached) to the bottom wall 3 by means of the respective side of the perimeter edge 3a.

Preferably, at least two side flaps 5 and one upper flap 6 extend from each perimeter side wall 4.

In that respect, note that the terms “side” and “upper” are used here to refer to the side wall of the container in a condition of use, that is, with the bottom wall 3 of the box-like body 2 resting on a horizontal plane.

According to one aspect of the present invention, each side flap 5 is connected to the respective side wall 4 through a respective side folding line 5a and abuts against and is bonded to a respective adjacent side flap 5, defining a supporting element 7 on the outside of said containment volume “V”.

In other words, each side flap 5 has an inner face that abuts against the inner face of the adjacent flap, since only the outer face of one or of both of the flaps faces the outside of the container 1.

Preferably, each pair of adjacent side flaps 5 comprises a layer of heat-sealed lacquer interposed between the flaps 5 and suitable to bond them to each other.

The layer of lacquer is preferably applied to the inner face of the side flaps 5 before the container is formed, in order to facilitate the forming process.

In the preferred embodiment, each supporting element 7 abuts against and is bonded to one of the adjacent side walls 4 (on the outside).

In other words, the supporting element 7 is folded so that one of the side flaps 5 defining it has its outer face abutting against and bonded to the corresponding side wall 4 (on the outside thereof).

Advantageously, this helps to stiffen the structure of the container and reduce its overall dimensions.

According to a further aspect of the invention, each upper flap 6 is connected to the respective side wall 4 through a respective first upper folding line 6a.

Each upper flap 6 is thus folded along the first upper folding line 6a, away from the containment volume “V” and so as to form a shelf.

The upper flaps 6 thus each define an edge portion 8 of the container suitable to receive the closure element.

In other words, the presence of a supporting shelf at the end of the side walls 4 defines a space that is sufficient to abut against the closure element and heat-seal it to the edge portions 8.

Preferably, each upper flap 6 at least partially overlaps and is bonded to at least one adjacent upper flap 6, so that said upper flaps 6 define a continuous edge “E” of the container 1.

The continuous edge “E” is thus substantially annular and defined by all of the edge portions 8 which partially overlap one another in the area of respective overlap fins.

Note that the adjacent upper fins preferably have a layer of heat-sealed lacquer interposed between them and suitable to bond them to one another.

More precisely, the overlap fins of each pair of upper flaps 6 are bonded to one another by a layer of heat-sealed lacquer or other permanent adhesive.

Preferably, moreover, each upper flap comprises a folded portion 9 which is folded in relation to said edge portion 8 along a second upper folding line 6b.

The second upper folding line 6b is thus external and at least partially parallel to the first upper folding line 6a.

Thus, preferably, each upper flap 6 has an edge portion 8, arranged at an angle to the side wall 4 and projecting outwards from said wall, and the folded portion 9, defining a hook or a curve in relation to the edge portion 8.

Advantageously, the second upper folding line 6b, together with the presence of a continuous edge “E”, defines a continuous folded edge and a reinforcing and stiffening belt for the structure of the container 1.

Note that each edge portion 8 has a first surface for connection to said closure element and a second surface opposite to the first.

Preferably, the folded portion 9 abuts against and is bonded to the second surface of the edge portion so as to define a continuous reinforced edge of said container 1.

In the preferred embodiment, the folded portion 9 and the edge portion 8 are joined by means of a layer of heat-sealed lacquer.

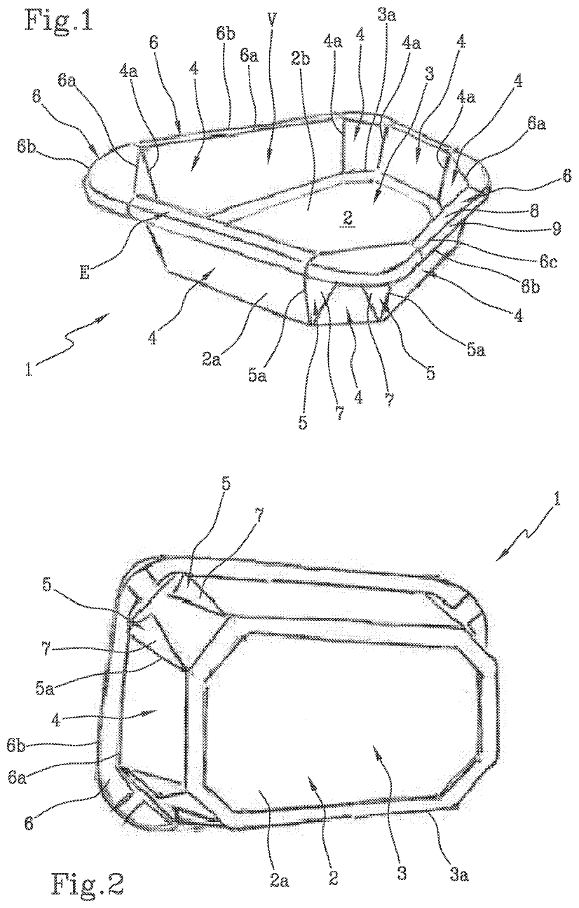

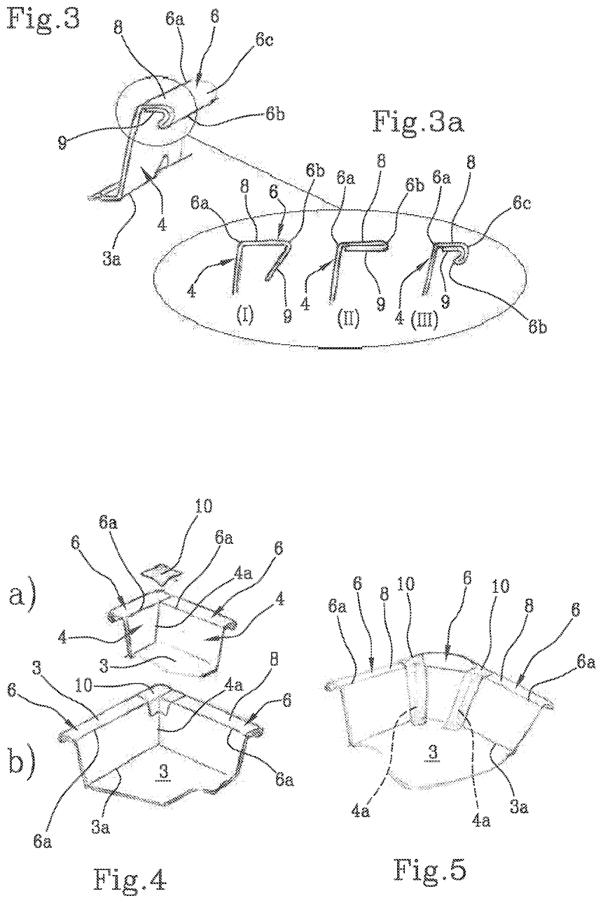

With reference to FIGS. 1-3, note that the continuous reinforced edge (that is, the edge portion 8 and the folded portion 9 abutting against one another) is preferably at least partially curved towards the side wall 4 along a third upper folding line 6c.

The third upper folding line 6c is preferably interposed between the first 6a and the second upper folding line 6b.

In the preferred embodiment, the third upper folding line 6c and the second upper folding line 6b are substantially parallel (and concentric).

Advantageously, the presence of an edge provided with a double overlapping layer (the edge portion 8 and the folded portion 9) and with an additional reinforcing fold (the third upper folding line 6c) makes the container very strong from a mechanical perspective even when the material used to make the box-like body 2 has a very reduced thickness.

According to a preferred aspect of the present invention, each pair of adjacent (partially overlapping) upper flaps comprises a first upper flap 6′ and a second upper flap 6″ which are joined to one another and partially overlap.

As already stated, the first upper flap 6′ preferably comprises the folded portion 9′ which is folded in relation to the edge portion 8′ along the second upper folding line 6b′.

Moreover, the first upper flap 6′ is provided with at least one lower extension fin 11a adjacent to and coplanar with the folded portion 9.

In other words, the length of the edge portion 8′ of the first upper flap 6′ is substantially the same as that of the second upper folding line 6b′, while the folded portion 9′ extends further owing to the presence of the lower extension fin 11a.

The lower extension fin 11a has an upper face and a lower face defined, respectively, by the first layer 2a and by the second layer 2b of the box-like body 2. Therefore, as the upper face of the lower extension fin 11a is part of the folded portion 9′, it is defined by the outer layer (compostable and/or recyclable) of the box-like body 2.

The second upper flap 6″ instead comprises an upper extension fin 11b adjacent to and coplanar with the respective edge portion 8″.

The lower extension fin 11a has an upper face and a lower face defined, respectively, by the second layer 2a and by the first layer 2b of the box-like body 2. Therefore, as the lower face of the upper extension fin 11b is part of the edge portion 8″ (not folded), it is defined by the outer layer (compostable and/or biodegradable) of the box-like body 2.

According to this aspect of the invention, the outer layer of said lower extension fin 11a abuts against and is bonded to the outer layer of the upper extension fin 11b so that the upper extension fin 11b is coplanar with the edge portion 8′ of the first upper flap 6′.

Advantageously, said structure makes it possible to define an edge “E” of the container 1 which, in addition to being continuous, is flat, in that it has no steps or dips.

This facilitates the connection between the container 1 and the closure element and guarantees a completely gas-tight seal along the edge “E”.

In that respect, note that the connected faces of the extension fins are preferably made of compostable and/or biodegradable material (paper/cardboard), and can therefore be fastened by means of adhesive with good sealing properties.

Indeed, each upper extension fin 11b is preferably bonded to the respective lower extension fin 11a by means of a layer of heat-sealable lacquer interposed between them.

The layer of lacquer is preferably applied to one or both of the outer layers of the extension fins at the level of the blank and then activated in the joining step.

Advantageously, in this way the “mechanical” seal of the connection is considerably increased.

Note that the second upper flap 6″ preferably comprises, in turn, a folded portion 9″ adjacent to and coplanar with the lower extension fin 11a of the first upper flap 6′.

The length of the folded portion 9″ of the second upper flap 6″ is thus the same as that of the second upper folding line 6b″ (less than that of the edge portion 8′ including the upper extension fin 11b).

Advantageously, in this way the edge has a constant thickness along the entire perimeter of the container, which makes it stiffer and gives it a more attractive appearance.

Note that the bottom wall 3 and the continuous edge “E” preferably differ in shape; in particular, the bottom wall 3 is preferably polygonal, whereas the continuous edge “E” has rounded corners.

In that respect, at least two upper flaps 6 preferably have respective second upper folding lines 6b with a curved shape, with the concavity facing towards the first upper folding line 6a.

With reference to FIGS. 1 and 2, for example, note that the bottom wall has a plurality of corner side walls 4′, each with a respective curved upper flap 6.

Advantageously, in this way it is possible to adapt the typical polygonal shape of the containers made starting from a blank with the curved edges normally used in food packaging, by means of heat-sealed closure elements.

According to a further aspect of the invention, additional or alternative to those described above, the container 1 further comprises a plurality of overlapping sealing elements 10 bonded to said inner layer 2b, in the area of the connection lines 4a and at least partially arranged over the respective edge portion 8 of the container 1.

Advantageously, in this way the only part of the container where leaks could occur (linked to the folding of the fins and bringing them together) is sealed locally, thus guaranteeing the complete gas tightness of the container 1.

In that respect, note that the sealing elements 10 are bodies that are separate from the inner layer 2b of the box-like body 2, which they overlap to define a further seal in addition to that defined by the inner heat-sealed layer 2b.

In the preferred embodiment, the sealing elements 10 are adhesive strips arranged, respectively, astride two adjacent side walls 4 and/or two adjacent upper flaps 6.

More precisely, each sealing element 10 is preferably defined by a strip arranged at a point of intersection between a connection line 4a and the corresponding first upper folding line 6.

In certain embodiments, the strip runs along the entire connection line 4a, from the bottom wall 3 up to the edge portion 8.

Note that, preferably, the strips are defined by bands of plastic material, heat-sealed or glued to the inner layer 2b of the box-like body 2.

However, alternatively, the sealing elements 10 could be defined by the fusion of a certain amount of plastic powder deposited on said connection lines 4a.

According to a further aspect of the invention, also additional or possibly alternative to those described above, the bottom wall 3 has at least one window 12 bounded by at least two side edges 13 at least partially facing one another.

Preferably, the bottom wall 3 has at least one partition wall 14 rising transversely from at least one of the side edges 13 of the window 12 and towards the inside of the containment volume “V” up to a free end thereof 14a.

Preferably, there are at least two partition walls 14, each rising from a respective edge 13 of the window 12.

Note that, in the preferred embodiments, the edges 13 from which a partition wall 14 rises are creases/folding lines that facilitate its transverse positioning during the forming step (as described in more detail later on).

In that respect, each partition wall 14 preferably rises transversely to said bottom wall with which it defines an angle of inclination of between 90° and 150°, more preferably of approximately 90°.

According to this aspect of the invention, the container 1 comprises a cover element 15 heat-sealed to the inner layer 2b of the bottom wall 3 and arranged astride said at least two edges 13 so as to occlude the window 12.

The cover element 15 is arranged over the free end 14a of the partition wall 14 and thus defines a bulge in the bottom wall 3.

Preferably, the cover element 15 is arranged over the free end 14a of both partition walls 14. More preferably, the area of said window 12 is equal to the sum of the areas of said at least two partition walls 14.

Advantageously, thanks to this structure, bulges and portions for supporting foodstuffs can also be obtained in containers made of paper/cardboard, or in any case not made of plastic material, extending the range of products for which the containers to which the invention refers can be suitable.

Preferably, the cover element 15 is defined by a sheet 15a of plastic material. In that respect, the sheet 15a is connected to the inner layer 2b of the bottom wall 3 by means of a junction strip 16 surrounding the window 12.

In other words, the junction strip 16 is a closed line/area that completely surrounds the window and defines the only area of coupling/bonding between the cover element 15 and the bottom wall 3.

In that respect, the junction strip 16 is preferably defined by a fusion/heat seal between the inner layer 2b of the bottom wall 3 (made of plastic material) and the cover element 15.

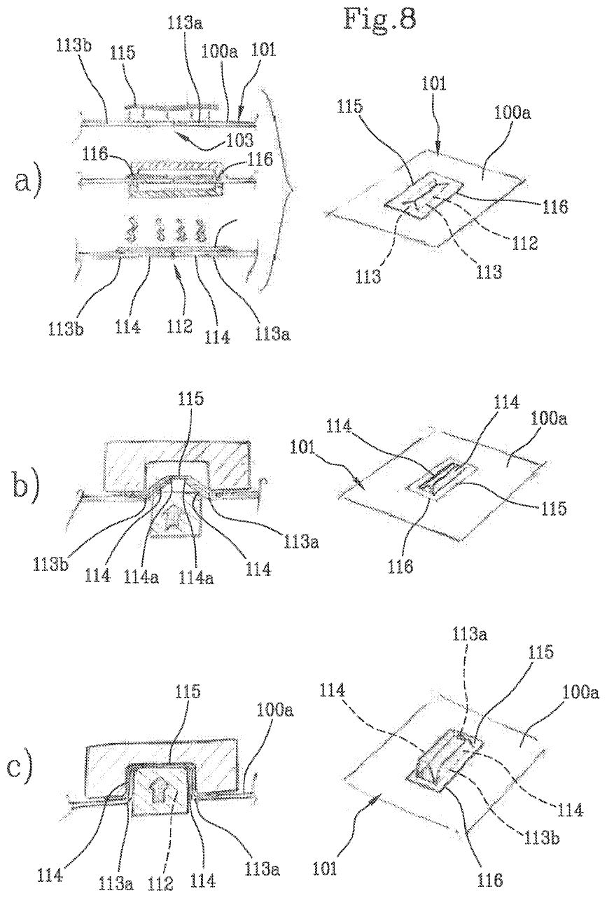

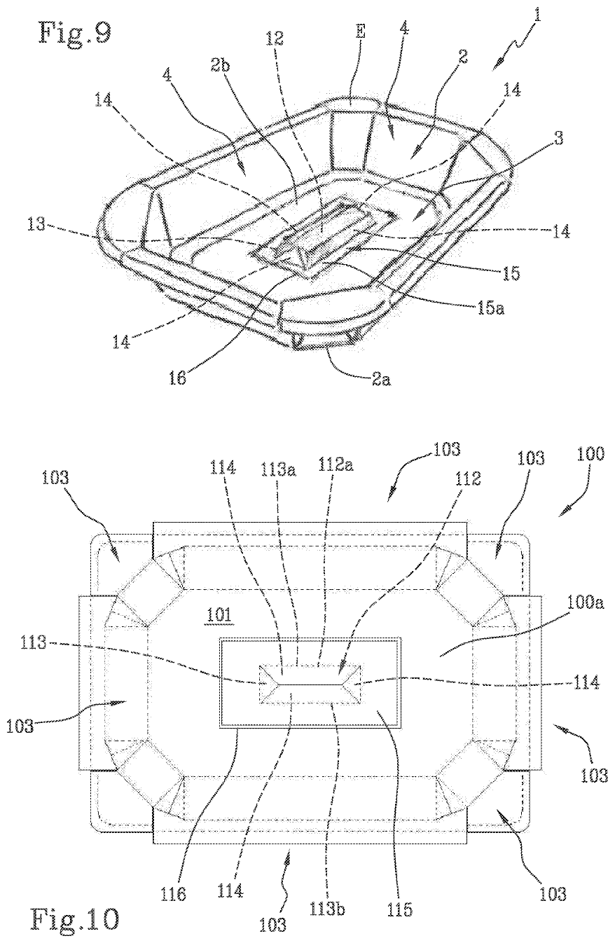

With reference to that illustrated in FIGS. 8-10, the window 12 preferably has a polygonal shape (more preferably a rectangular shape) and is delimited by a plurality of edges 13 defining a closed broken line from which a corresponding plurality of partition walls 14 rise, each partition wall having a respective free end over which the cover element 15 is arranged. In the preferred embodiment, there are four partition walls 14.

The present invention also relates to a method for manufacturing a container for foodstuffs, preferably but not exclusively of the type described above.

In that context, all that stated above applies mutatis mutandis to each step of the method described below, where the characteristics illustrated refer to structural features of the container described above.

The method to which the invention refers starts with a flat blank 100 shaped so as to define the box-like body 2 after being formed.

The flat blank 100 has a first face 100a and a second face 100b which are opposite each other. Preferably, when in use, such faces represent the outer layer 2a and the inner layer 2b.

The blank 100 is at least partially made of recyclable and/or biodegradable and/or biocompostable material, preferably a cellulosic material, and is more preferably made of paper, card or cardboard.

More preferably, the blank 100 is mainly made of virgin long-fibre paper or kraft paper or wood fibre.

According to the preferred embodiment, the blank 100 is made of a multilayer material having a first heat-sealable layer (comprising the first face 100a, the inner face when in use), made of a gas-tight material suitable for coming into contact with food, and a second layer (comprising the second face 100b, the outer face in use) made of said recyclable and/or biocompostable material.

Preferably, the first inner layer is made of polyester or polypropylene or polythene or other suitable plastic materials.

The blank 100 further comprises a polygonal base panel 101 perimetrically bounded by a plurality of internal folding lines 102.

The base panel 100 corresponds to the bottom wall 3 of the box-like body 2. The internal folding lines thus define the perimeter edge 3a of the bottom wall 3.

A plurality of side panels 103, equal in number to said plurality of internal folding lines 102, branch off from the base panel 101.

Each side panel 103 is connected to the base panel 101 through a corresponding internal folding line 102.

Preferably, each side panel 103 is provided with a central portion 104, a pair of side tabs 105 and an external tab 106.

The central portion 104 corresponds to a side wall 4 of the box-like body 2 and is connected to said base panel 101 by the internal folding line 102.

The side tabs 105 are arranged on opposite sides of said central portion 104 to which they are connected by side folding lines 105a.

Said side tabs 105 thus correspond to the side flaps 5 and the side folding lines 105a correspond to the side folding lines 5a.

The external tab 106 is arranged outside the central portion 104 to which it is connected by a first external folding line 106a. The external tabs 106 of the blank 100 thus correspond to the upper flaps 6 of the container 1, where the first external folding line 106a is the first upper folding line 6a.

The method thus consists in preforming said blank by at least partially folding, in the area of said first face 100a, said side panels 103 with respect to said base panel 101 along said internal folding lines 103a.

The blank is then formed so as to obtain the container 1.

Preferably, in that respect, the method consists in moistening the blank 100 and, subsequently, drying it after the preforming step or, more preferably, during or after said forming.

Preferably, before being formed, the blank 100 is subjected to at least one steam flow at a predetermined temperature, to make it easier to shape.

The drying step, instead, preferably consists in the use of heated blocks that are pressed against said side panels 103 during the forming step, to maximise the efficiency of forming.

More in detail, the forming step preferably consists in folding said side tabs 105 along said side folding lines 105a until, in the area of said first face 100a, each side tab 105 of a side panel 103 abuts against a corresponding side tab 105 of an adjacent side panel 103.

Next (or at the same time), the side tabs 105 abutting against each other are bonded to one another in the area of the first face 100a, thus defining the supporting elements 7 of said box-like body 2.

In that respect, the first face 100a of the side tabs 105 preferably has a layer of heat-sealable lacquer which, during said bonding step, is activated to bond the tabs to one another.

In some preferred embodiments, the supporting element 7, that is, the pair of side tabs 105, is folded again along the side folding line 105a until the second face 100b of one of the side tabs 105 abuts against the second face 100b of the corresponding central portion 104.

With reference to the external tabs 106, each of these is preferably folded along the respective first external folding line 106a so as to define the edge portion 8 of the container 1.

This folding step is performed after the preforming step, after or during the step to obtain the supporting elements 7.

According to one aspect of the invention, each external tab 106 partially overlaps, and is bonded to, at least one adjacent external tab 106 so as to define a continuous edge “E” of the container.

Thus, in that respect, each of the external tabs 106 has at least one overlapping section that is provided with a layer of heat-sealable lacquer (or other similar adhesive) which, in the forming step, is activated by applying heat.

Preferably, moreover, each external tab 106 is also folded along a respective second external folding line 106b so as to define a folded portion 9 of the edge of the container 1.

The second external folding line 106b thus corresponds to the second upper folding line 6b of the upper tab 6 and is arranged in a position distal to the base panel 101 in relation to the first external folding line 106a.

Advantageously, in this way the container 1 obtained according to the method described herein has good rigidity and robustness even in the case of a blank of reduced thickness.

According to a further innovative aspect of the method (FIGS. 4-5), additional or alternative to that described above, the method comprises the step of applying and bonding a plurality of sealing elements 10 overlapping them in the area of the connection lines 4a and arranging them at least partially over the respective edge portions 8 of the container 1.

This step may be performed by applying the sealing elements 10 during the forming process or, alternatively, subsequently by nebulising/applying molten and subsequently dried plastic particles.

According to the former alternative, the method could consist in applying the sealing elements 10 (in the form of adhesive strips) to the abutment elements inside the forming machine, to ensure their correct positioning during the forming of the container 1.

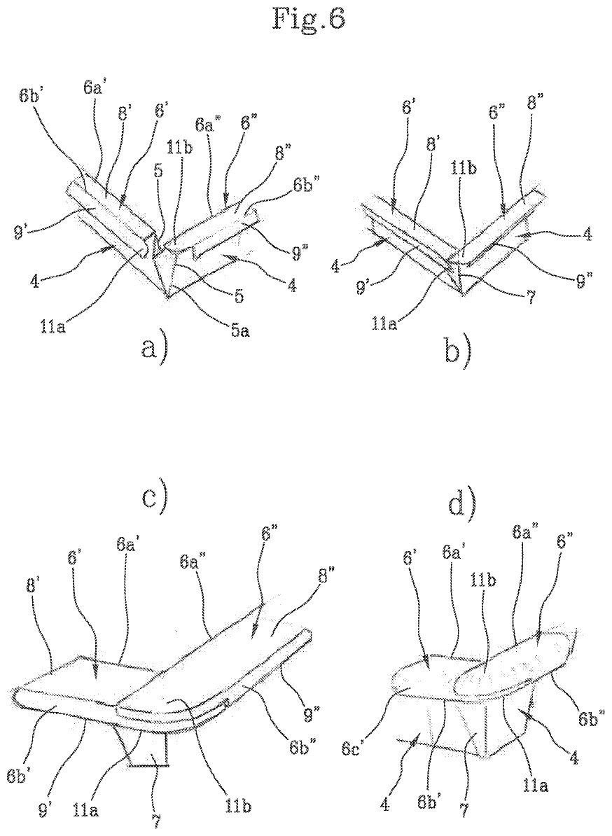

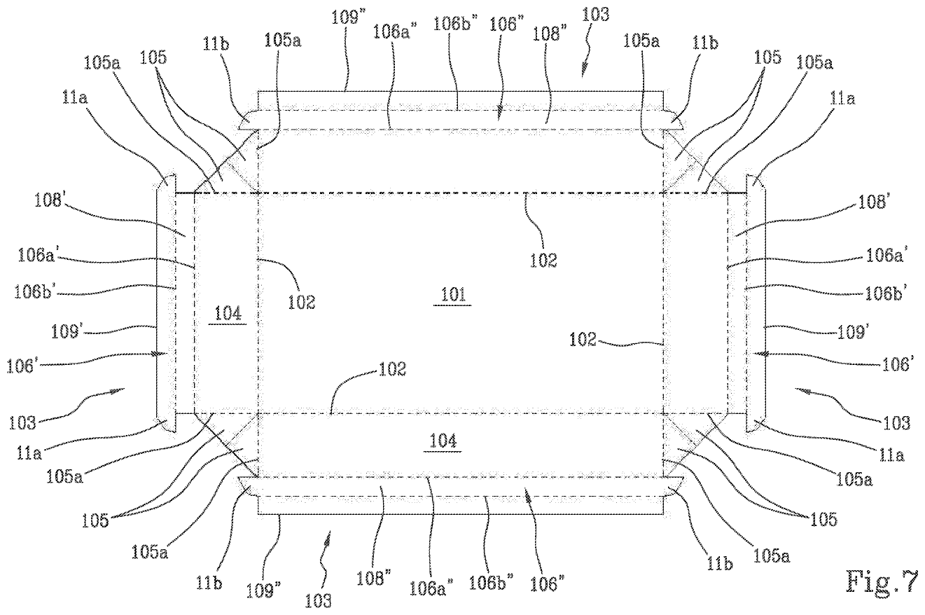

According to a further inventive aspect (FIGS. 6-7), the blank 100 could comprise, for each pair of adjacent side panels 103, a respective first 106′ and second external tab 106″.

The first external tab 106′ comprises the first 106a′ and the second external folding line 106b′.

A first portion 108′ of the first external tab 106′ is bounded between said external folding lines 106a′, 106b′, whereas a second portion 109′ of the first external tab 106 extends starting from the second external folding line 106a′ away from the first external folding line 106a′.

This second portion 109′ is provided with at least one extension fin 11a projecting laterally with respect to the first portion 108′.

The second external tab 106″ comprises, in turn, at least a first portion 108″ adjacent to the first external folding line 106a″ and is provided with at least one extension fin 11b projecting laterally with respect to the respective central portion 104.

According to said shape of the blank 100, the forming step consists in folding the second portion 109′ of the first external tab 106′ until it abuts underneath the first portion 108′, so that the extension fin 11a projects laterally and from the bottom of said portion with its second face facing upwards.

At this point, the second face of said extension fin 11a of the first external tab 106′ is made to abut against the second face of said extension fin 11b of the second external tab 106″, so that said extension fin 11b is coplanar with the first portion 108′ of the first external tab 106′ so as to define a continuous edge “E” of said container 1.

Next (or at the same time), said extension fins are bonded to one another, preferably by means of heat sealing or by activating a previously applied heat-sealable lacquer.

Advantageously, in this way it is possible to obtain a container made of material such as paper or card with gas-tightness properties comparable to those of the plastic containers currently available on the market.

With reference to a further aspect of the present invention (FIGS. 8-10), additional or alternative to those described above, the base panel 101 of the blank could be provided with a window 112 bounded by a closed perimeter line 112a with at least a first 113a and a second edge 113b at least partially facing one another.

The window 112, at the level of the blank 100, is at least partially occluded by a partition wall 114 pivotally attached to the panel 101 in the area of said first edge 113a.

At this point, the method consists in arranging a sheet 115 of heat-sealable plastic material over said window 112 in the area of said first face 100a so that said sheet 115 is arranged over said closed line 112a and completely covers said window 112.

At this point, the sheet 115 of heat-sealable plastic material is bonded (heat-sealed) to the first face 100a of the base panel 101, along a closed sealing line 115a outside said closed perimeter line 112a delimiting the window.

Preferably, this bonding step is performed by means of appropriately shaped heat-sealing dies.

Note that, after or during the bonding step, the sheet 115 is preferably heated to soften it and make it more easily deformable.

After fastening the sheet 115 to the base panel 101, the partition wall 113 is pushed against said sheet 115 folding it along said first edge 113a until it is arranged transversely (preferably orthogonally) to the first face 100a.

In the preferred embodiment, there are at least two partition walls 113 pivotally attached to the base panel 101 along both of the edges 113a 113b, and they are both pushed/turned, so that the sheet 115 is raised and deformed.

This sheet 115 of heat-sealable plastic material is configured to deform following the movement of each partition wall 113 so as to cover it, keeping said window 112 covered and defining a bulge in a bottom wall 3 of said container 1.

In that respect, note that the plastic deformation of the sheet causes it to become thinner, so that, once deformed, the sheet 15 described previously with reference to the container 1 has a larger surface area and a reduced thickness than the sheet 115 described here and applied to the base panel in the non-deformed configuration.

Moreover, sealing the sheet 115 to the base panel 101 along a sealing line 115a located outside the window 112, makes it considerably easier to deform the sheet without breaking it, by permitting a relative sliding between the partition wall 113 and the respective “covering” portion of the sheet 115.

In the preferred embodiment, the pushing step is performed by means of a wedge or pushing member, inserted transversely to the window 112 from the second face 100b of the blank and counter-shaped with respect to said window 112.

The invention achieves the intended purposes and brings some important advantages.

The container 1 described above comprises a plurality of novel and independent features which make the structure robust (folded portion), give it excellent sealing properties (sealing elements and/or extension fins) and broaden the scope of application (bulges).

Thanks to these features, the container made mainly of cellulosic material is comparable to the plastic containers currently available on the market both in terms of efficiency (strength and seal) and in terms of shape, thus facilitating the use of existing heat-sealing machines to apply the closure elements.

Furthermore, the specific steps of the forming process to which the invention refers maximise the potential applications and possible uses for the container, which may be used to store dried as well as fresh foodstuffs.

1. A container for foodstuffs, comprising a containment body having a polygonal bottom wall and perimeter side walls connected to each other and to said polygonal bottom wall so as to define a food containment volume open at the top at an upper opening,
wherein at least two side flaps and one upper flap extend from each perimeter side wall,
wherein each side flap is connected to the respective side wall through a respective side folding line and abuts against and is bonded to a respective adjacent side flap, defining a supporting element outside said containment volume,
wherein each upper flap is connected to the respective side wall through a respective first upper folding line along which it is folded away from the containment volume so as to define an edge portion of the container suitable to receive a closure element,
wherein each upper flap comprises a folded portion, which is folded in relation to said edge portion along a second upper folding line,
wherein each upper flap at least partially overlaps and is bonded to at least one adjacent upper flap so that said upper flaps define a continuous folded edge of the container.

2. The container according to claim 1, wherein said edge portion has a first surface connected to said closure element, and a second surface opposite to the first; said folded portion abuts against and is bonded to said second surface of the edge portion so as to reinforce the reinforced continuous edge of said container.

3. The container according to claim 2, wherein said reinforced continuous edge is at least partially curved towards the side wall along a third upper folding line.

4. The container according to claim 1, wherein at least two perimeter side walls have respective second upper folding lines having a curved shape.

5. The container according to claim 1, wherein each supporting element abuts against and is bonded to one of the side walls adjacent to it.

6. The container according to claim 1, wherein each pair of adjacent side flaps and/or adjacent upper flaps comprises a layer of heat-sealed lacquer interposed between the flaps and suitable to bond them to each other.

7. The container according to claim 1, comprising a closure element, preferably a sheet of heat-sealable plastic material, sealed to the continuous edge to close the upper opening of the container.

8. A method for manufacturing a container for foodstuffs, comprising the steps of:
preparing a flat blank having a first face and a second face opposite to each other and comprising:
a polygonal base panel perimetrically bounded by a plurality of internal folding lines, and
a plurality of side panels, equal in number to said plurality of internal folding lines, connected to said base panel in the area of said internal folding lines,
wherein each side panel is provided with a central portion connected to said base panel, a pair of side tabs arranged on opposite sides of said central portion and connected to said central portion by side folding lines, and an external tab arranged outside said central portion and connected thereto by a first external folding line;
preforming said blank by at least partially folding, in the area of said first face, said side panels with respect to said base panel along said internal folding lines;
forming said blank so as to obtain a container for foodstuffs comprising a containment body in which a polygonal bottom wall corresponds to said base panel and the perimeter side walls correspond to said central portions of the side panels, so as to define a containment volume, said forming step comprising the following sub-steps:
folding said side tabs along said side folding lines until, in the area of said first face, each side tab of a side panel abuts against a corresponding side tab of an adjacent side panel,
bonding said side tabs abutting against each other, thus defining supporting elements of said containment body outside said containment volume,
folding each external tab along the respective first external folding line so as to define an edge portion of the container, which is suitable to receive a closure element,
further folding each external tab along a respective second external folding line so as to define a folded portion of said external tab,
arranging each external tab so that it partially overlaps and is bonded to at least one adjacent external tab so as to define a continuous folded edge of the container.

9. The method according to claim 8, wherein said step of preparing the blank comprises a sub-step of moistening said blank, and wherein said method comprises a step of drying the blank by heating said preformed blank during or after said forming process.

10. The method according to claim 9, wherein said moistening sub-step is carried out by striking said blank with at least one steam flow at a predetermined temperature.

11. A container for foodstuffs, comprising a box-like body manufactured with a multilayer material having an outer layer made of a recyclable and/or biocompostable material and a heat-sealable inner layer, which is gas-tight and made of a material suitable to come into contact with food,
wherein said box-like body has a polygonal bottom wall and perimeter side walls connected to each other along respective connection lines and to said polygonal bottom wall so as to define a food containment volume facing said inner layer and open at the top at an upper opening,
wherein at least two side flaps and one upper flap extend from each perimeter side wall,
wherein each side flap is connected to the respective side wall through a respective side folding line, defining a connection line connecting the respective perimeter side wall, and abuts against and is bonded to a respective adjacent side flap, defining a supporting element outside said containment volume,
wherein each upper flap is connected to the respective side wall through a respective first upper folding line along which it is folded away from the containment volume so as to define an edge portion of the container suitable to receive a closure element,
said container further comprising a plurality of overlapping sealing elements bonded to said inner layer in the area of said connection lines and at least partially overlapping the respective edge portion of the container.

12. The container according to claim 11, wherein the sealing elements are adhesive strips respectively arranged astride two adjacent side walls and/or two adjacent upper flaps.

13. The container according to claim 11, wherein the sealing elements are defined by the fusion of a certain quantity of plastic powders deposited in the area of said connection lines.

14. The container according to claim 11, wherein each pair of adjacent perimeter side walls has a corresponding pair of adjacent upper flaps, wherein:
a first upper flap comprises a folded portion, which is folded in relation to said edge portion along a second upper folding line and provided with at least one lower extension fin which is adjacent to and coplanar with said folded portion;
a second upper flap comprises at least one upper extension fin, which is adjacent to and coplanar with the respective edge portion,
wherein the outer layer of said lower extension fin abuts against and is bonded to the outer layer of the upper extension fin, and said upper extension fin is coplanar with the edge portion of the first upper flap so as to define a continuous edge of said container.

15. The container according to claim 14, wherein the second upper flap also comprises a folded portion, which is folded in relation to said edge portion along a second upper folding line, adjacent to and coplanar with the lower extension fin of the first upper flap.

16. The container according to claim 14, wherein each upper extension fin is bonded to the respective lower extension fin by means of a layer of heat-sealable lacquer.

17. A method for manufacturing a container for foodstuffs, comprising the steps of:
preparing a flat blank manufactured with a multilayer material having an outer layer made of a recyclable and/or biocompostable material, defining a second face of said blank, and a heat-sealable inner layer, which is gas-tight and made of a material suitable to come into contact with food, defining a first face of said blank, wherein said blank comprises:
a polygonal base panel perimetrically bounded by a plurality of internal folding lines, and
a plurality of side panels, equal in number to said plurality of internal folding lines, connected to said base panel in the area of said internal folding lines,
wherein each side panel is provided with a central portion connected to said base panel, a pair of side tabs arranged on opposite sides of said central portion and connected to said central portion by side folding lines, and an external tab arranged outside said central portion and connected thereto by a first external folding line;
preforming said blank by at least partially folding said side panels with respect to said base panel along said internal folding lines;
forming said blank so as to obtain a container for foodstuffs comprising a box-like body in which a polygonal bottom wall corresponds to said base panel and the perimeter side walls correspond to said central portions of the side panels, so as to define a containment volume, said forming step comprising:
folding each external tab along the respective first external folding line so as to define an edge portion of the container, which is suitable to receive a closure element,
applying a plurality of sealing elements, overlapping them in the area of said connection lines and arranging them at least partially over the respective edge portions of the container,
bonding said sealing elements to said box-like body.

18. The method according to claim 17, wherein the forming step further comprises:
folding said side tabs along said side folding lines until the first faces of each side tab of a side panel and of a corresponding side tab of an adjacent side panel abut against each other,
bonding said side tabs abutting against each other, thus defining supporting elements of said box-like body outside said containment volume.

19. The method according to claim 17, wherein each pair of adjacent side panels of the blank has a corresponding pair of adjacent external tabs, wherein:
a first external tab is provided with a first portion, which is bounded between said first and said second external folding line, and a second portion, which extends starting from the second external folding line away from the first external folding line; said second portion being provided with at least one extension fin projecting laterally with respect to the first portion;
a second external tab comprises at least a first portion adjacent to the first external folding line and provided with at least one extension fin projecting laterally with respect to the respective central portion, and wherein the forming step further comprises:
folding the second portion of the first external tab until it abuts underneath the first portion, so that the extension fin projects laterally and from the bottom;
abutting the second face of said extension fin of the first external tab against the second face of said extension fin of the second external tab, so that said extension fin is coplanar with the first portion of the first external tab so as to define a continuous edge of said container;
bonding said extension fins to one another.

20. A container for foodstuffs, comprising a box-like body manufactured with a multilayer material having an outer layer made of a recyclable and/or biocompostable material and a heat-sealable inner layer, which is made of a material suitable to come into contact with food,
wherein said box-like body has a bottom wall and perimeter side walls connected to each other and to said bottom wall so as to define a food containment volume facing said inner layer and open at the top at an upper opening,
wherein said bottom wall has at least one window bounded by at least two side edges at least partially facing one another,
and wherein said bottom wall has at least one partition wall rising transversely from at least one of said side edges of the window and towards the inside of the containment volume up to a free end thereof,
said container comprising a cover element heat-sealed to the inner layer of the bottom wall and arranged astride said at least two edges so as to occlude the window, wherein the cover element is arranged over said free end of the partition wall and defines a bulge in the bottom wall.

21. The container according to claim 20, comprising two partition walls facing each other, each rising from a respective edge towards a respective free end, and wherein said cover element is arranged over both free ends of said partitions.

22. The container according to claim 20, wherein said cover element is defined by a sheet of plastic material.

23. The container according to, claim 20, wherein said cover element is connected to the bottom wall by means of a junction strip surrounding the window.

24. The container according to claim 20, wherein said window has a polygonal, preferably rectangular shape.

25. The container according to claim 24, wherein the area of said window is equal to the sum of the areas of said at least two partition walls.

26. The container according to claim 20, wherein said window has a polygonal, preferably rectangular shape defined by a plurality of edges from which a corresponding plurality of partition walls rise; each partition wall having a respective free end over which the cover element is arranged.

27. The container according to claim 20, wherein each partition wall rises transversely to said bottom wall and defines therewith an angle of inclination of between 90° and 150°.

28. A method for manufacturing a container for foodstuffs, comprising the steps of:
preparing a flat blank manufactured with a multilayer material having an outer layer made of a recyclable and/or biocompostable material, defining a second face of said blank, and a heat-sealable inner layer, which is gas-tight and made of a material suitable to come into contact with food, defining a first face of said blank,
said blank comprising a base panel perimetrically bounded by at least one internal folding line, and at least one side panel connected to said base panel in the area of said internal folding line,
wherein said base panel has a window bounded by a closed perimeter line having at least a first and a second edge at least partially facing one another; said window being at least partially occluded by a partition wall pivotally attached to the panel at said first edge;
placing a sheet of heat-sealable plastic material over said window in the area of said first face so that said sheet of plastic material is arranged over said closed perimeter line and said window is completely covered by said sheet,
sealing said sheet of heat-sealable plastic material to said inner layer along a closed sealing line outside said closed perimeter line bounding the window,
pushing said partition wall against said sheet of heat-sealable plastic material by folding it along said first edge until it is arranged transversely to said first face, said sheet of heat-sealable plastic material being configured to deform following the movement of the partition wall, so as to cover it, keeping said window covered and defining a bulge in a bottom wall of said container.

29. The method according to claim 28, comprising a step of heating said sheet of heat-sealable plastic material, preferably after said sealing step.
